(19) United States
(12) Patent Application Publication
(10) Pub. No.: US 2015/0029456 A1
(43) Pub. Date: Jan. 29, 2015

(54) LAMINATE HAVING OPTICAL ANISOTROPY

(71) Applicant: FUJIFILM Corporation, Tokyo (JP)

(72) Inventor: Reona IKEDA, Kanagawa (JP)

(73) Assignee: FUJIFILM CORPORATION, Tokyo (JP)

(21) Appl. No.: 14/503,820

(22) Filed: Oct. 1, 2014

Related U.S. Application Data
(63) Continuation of application No. PCT/JP2013/060632, filed on Apr. 8, 2013.

(30) Foreign Application Priority Data
Apr. 10, 2012 (JP) 2012-089278

(51) Int. Cl. G02B 5/30

(52) U.S. Cl. CPC G02B 5/3016; G02B 5/3083
USPC 349/194; 427/162

(57) ABSTRACT

Provided is an optically anisotropic body having good coatability onto a laminate, in which the laminate includes an optically anisotropic layer formed of a composition including a liquid crystal compound by direct coating, and an isotropic resin layer formed on the optically anisotropic layer by direct coating, and has good coatability onto the isotropic resin layer. The laminate includes an optically anisotropic layer and an isotropic resin layer formed of a resin composition directly coated on the optically anisotropic layer, in which the optically anisotropic layer is a layer formed by curing a liquid crystal composition including a liquid crystal compound containing a polymerizable group; the isotropic resin layer is the outermost layer of the laminate; and the surface energy on the side of the isotropic resin layer of the laminate is 34.0 mN/m or more.

### CROSS-REFERENCE TO RELATED APPLICATIONS

This application is a Continuation of PCT International Application No. PCT/JP2013/060632 filed on Apr. 8, 2013, which claims priority under 35 U.S.C §119(a) to Japanese Patent Application No. 2012-089278 filed on Apr. 10, 2012. Each of the above application is hereby expressly incorporated by reference, in its entirety, into the present application.

### BACKGROUND OF THE INVENTION

1. Field of the Invention

The present invention relates to a laminate having optical anisotropy. More specifically, the present invention relates to a laminate including an optically anisotropic layer formed of a composition including a liquid crystal compound containing a polymerizable group, and an isotropic resin layer formed on the optically anisotropic layer by direct coating, in which there is improved coatability onto the isotropic resin layer.

2. Description of the Related Art

In an optically anisotropic film formed by orienting liquid crystal molecules and curing them as they are, it is possible to realize optical properties that cannot be obtained from stretched polymer films in the related art due to various orientation forms of the liquid crystal molecules. In particular, by using a compound containing two or more polymerizable groups as a liquid crystal compound, it is capable of providing a crosslinked structure to reinforce the physical resistance of the layer or to manufacture an optically anisotropic layer having patternwise birefringence (for example, JP2009-69793A).

It is known to add a surfactant to a liquid crystal composition in order to regulate the orientation of liquid crystal molecules at an interface between a liquid crystal composition and air, and improve the coatability in the coating layer as described above. There are known examples of using, as the surfactant, for example, a fluoride-containing surfactant such as a non-ionic fluoroalkylalkoxylate surfactant described in JP2000-98133A, a polymeric surfactant as described in JP2000-105315A, or an alkyl ether type surfactant as described in JP2007-333896A. However, due to use of the surfactant, the coatability onto the obtained optically anisotropic layer deteriorates, and thus, cissing of a layer laminated on the optically anisotropic layer, or the like has occurred in some cases. Further, the surfactant has also been transferred to the layer laminated on the optically anisotropic layer, thus causing cissing or the like during lamination on the layer in some cases, and as a result, it is difficult to laminate a plurality of layers on the optically anisotropic layer. In addition, when a polymer layer has been laminated on an upper layer of an optically anisotropic layer formed of a composition including a polymeric surfactant, there have been seen cases where the upper layer and the surfactant have caused layer separation, leading to clouding in some cases.

As a technique for improving the coatability onto an optically anisotropic layer, there are known examples using a liquid crystal composition formed by adding a hydrocarbon such as paraffin or a halogen-substituted hydrocarbon (JP2009-294358A and JP2009-242564A). However, there is known no examples are known of a configuration where the coatability in the lamination of a plurality of layers on an optically anisotropic layer is improved.

### SUMMARY OF THE INVENTION

It is an object of the present invention to provide a laminate including an optically anisotropic layer formed of a composition including a liquid crystal compound containing a polymerizable group, and an isotropic resin layer formed on the optically anisotropic layer by direct coating, in which there is good coatability onto an isotropic resin layer. In particular, the present invention has an object to provide a laminate which hardly causes a cissing problem when a layer is further formed on the isotropic resin layer.

The present inventors have made extensive studies in order to solve the above-described problems, and as a result, they have found that the problems can be solved by adding a specific surfactant to a composition including a liquid crystal compound to adjust a surface energy on the isotropic resin layer to 34.0 mN/m or more.

That is, the present invention provides the following (1) to (13).

(1) A laminate including an optically anisotropic layer and an isotropic resin layer formed of a resin composition directly coated on the optically anisotropic layer, in which the optically anisotropic layer is a layer formed by curing a liquid crystal composition including a liquid crystal compound containing a polymerizable group, the isotropic resin layer is the outermost layer of the laminate, and the surface energy on the side of the isotropic resin layer of the laminate is 34.0 mN/m or more.

(2) The laminate as described in (1), in which the liquid crystal compound has two or more polymerizable groups.

(3) The laminate as described in (1) or (2), in which the liquid crystal composition includes a non-ionic surfactant containing neither fluoride nor silicon.

(4) The laminate as described in (3), in which the average molecular weight of the surfactant is 6000 or less.

(5) The laminate as described in (3) or (4), in which the surfactant is an acetylene diol-based surfactant or acetylene glycol-based surfactant.

(6) The laminate as described in any one of (1) to (5), in which the liquid crystal composition does not include a non-ionic surfactant containing fluoride or silicon.

(7) The laminate as described in any one of (1) to (6), in which the molecules of the liquid crystal compound are horizontally oriented.

(8) The laminate as described in any one of (1) to (7), in which the resin composition does not include a non-ionic surfactant containing fluoride or silicon.

(9) The laminate as described in any one of (1) to (7), in which the resin composition does not include a non-ionic surfactant containing fluoride and a non-ionic surfactant containing silicon.

(10) The laminate as described in any one of (1) to (9), in which the resin composition includes a non-ionic surfactant containing neither fluoride nor silicon.

(11) The laminate as described in (10), in which the content of the non-ionic surfactant containing neither fluoride nor silicon in the resin composition is from 0.01% by mass to 1.0% by mass with respect to the solid mass of the isotropic resin layer.

(12) The laminate as described in any one of (1) to (11), in which the resin composition includes a solvent.

(13) The laminate as described in (12), in which in the resin composition, the solvent included in the resin composition is contained in the amount of 60% by mass to 99% by mass with respect to the total mass of the resin composition.

(14) The laminate as described in any one of (1) to (13), in which in the liquid crystal composition, the content of the non-ionic surfactant containing neither fluoride nor silicon is from 0.01% by mass to 0.5% by mass with respect to the total mass of the liquid crystal compound.

(15) The laminate as described in any one of (1) to (14), in which the thickness of the optically anisotropic layer is from 0.5 μm to 10 μm.

(16) The laminate as described in any one of (1) to (15), in which the thickness of the isotropic resin layer is from 0.4 μm to 5 μm.

(17) A laminate including an additional layer formed of a composition directly coated on the isotropic resin layer of the laminate as described in any one of (1) to (16).

(18) A method for manufacturing a laminate including an optically anisotropic layer, an isotropic resin layer, and an additional resin layer in this order, adjacent to each other, including a step of curing a liquid crystal composition including a liquid crystal compound containing a polymerizable group to form an optically anisotropic layer, a step of coating a resin composition directly onto the optically anisotropic layer to form an isotropic resin layer having a surface energy of 34.0 mN/m or more, and a step of coating the composition directly onto the isotropic resin layer to form an additional layer.

According to the present invention, a laminate including an optically anisotropic layer formed of a composition including a liquid crystal compound containing a polymerizable group, and an isotropic resin layer formed on the optically anisotropic layer by direct coating, in which the coatability onto an isotropic resin layer is good in the preparation process is provided.

### DESCRIPTION OF THE PREFERRED EMBODIMENTS

The present invention will be described in detail below.

Further, in the present specification, the term “to” is used to mean that the upper limit value and lower limit value of the numerical values indicated before and after it are included.

In the present specification, Re denotes retardation (phase differential). Re can be measured by employing a spectral phase differential method by conversion from a transmission or reflection photospectrum to a phase differential using the method described in the Journal of the Optical Society of America, vol. 39, p. 791-794 (1949) or JP2008-256590A. The above references are directed to measurement methods which employ transmission spectra. However, since the light passes through the optically anisotropic layer twice, particularly in the case of reflection, half of the phase differential converted from the reflection spectrum can be employed as the phase differential of the optically anisotropic layer. The retardation (Re) indicates a frontal retardation unless specifically indicated. Re(λ) is the retardation employing light at a wavelength λ nm as the measurement light. The Re in the present specification means the retardation measured at the wavelengths of 611±5 nm, 545±5 nm, and 435±5 nm for R, and B, and means the retardation measured at a wavelength of 545±5 nm when no reference to color is given.

In the present specification, the term “essentially” in reference to an angle means that the difference from the precise angle falls within a range of less than ±5°. The difference from the precise angle is preferably less than 4°, and more preferably less than 3°. In reference to retardation, the term “essentially” means a difference in retardation of within ±5°, inclusive. Further, a “retardation of essentially 0” means a retardation of 5 nm or less. Further, the wavelength at which a refractive index is measured refers to any wavelength within the visible light region unless specifically stated otherwise. In addition, in the present specification, the term “visible light” refers to light with a wavelength of from 400 nm to 700 nm.

In the present specification, the term “solid mass” means the mass of a residue after the volatile matter has been volatilized.

[Laminate]

The laminate according to the present invention includes an optically anisotropic layer and an isotropic resin layer. The isotropic resin layer is the outermost layer of the laminate, which has a surface energy on the side of the isotropic resin layer of 34.0 mN/m or more. By adjusting the surface energy on the side of the isotropic resin layer to 34.0 mN/m or more, the coatability onto an isotropic resin layer can be improved. In the present specification, an additional layer may be provided and formed on the isotropic resin layer of the laminate, which is referred to as a “laminate”. In this laminate, the isotropic resin layer may not be the outermost layer of the laminate.

[Surface Energy]

The surface energy on the side of the isotropic resin layer of the laminate having an isotropic resin layer as the outermost layer is 34.0 mN/m or more, and preferably from 40 mN/m to 50 mN/m.

The surface energy γs can be calculated by using a contact angle, in which the contact angle of pure water and methylene iodide to the side of the isotropic resin layer of the laminate is measured. For this calculation, for example, an extended Fowkes equation, used in Examples below, can be employed.

[Optically Anisotropic Layer]

The optically anisotropic layer in the laminate of the present invention may have one incident direction, in which the retardation as measured is not essentially 0, that is, the layer is a layer having an optical property characterized by not being isotropic. The optically anisotropic layer may be an optically anisotropic layer, which is patterned.

In the present invention, preferably, the optically anisotropic layer is formed of a liquid crystal composition including a liquid crystal compound containing a polymerizable group, and a non-ionic surfactant not containing fluoride and silicon and having an average molecular weight of 6000 or less.

The optically anisotropic layer preferably has a retardation of 5 nm or more at 20° C., more preferably from 10 nm to 10000 nm, and most preferably from 20 nm to 2000 nm.

Examples of the method of preparing the optically anisotropic layer include a method of coating a liquid crystal composition as a solution on a support or the like, drying the coated layer to form a liquid crystal phase, and then heating it or irradiating it with light to fix and prepare the layer by the polymerization of the liquid crystal compound. The thickness of the optically anisotropic layer is preferably from 0.1 μm to 20 μm, and more preferably from 0.5 μm to 10 μm.

[Liquid Crystal Compound]

Generally, liquid crystal compounds can be classified into a rod-shaped type and a disc-shaped type according to the shapes. Further, each category further includes a low-molecular-weight type and a high-molecular-weight type. The high molecular type generally refers to one having a degree of polymerization of 100 or more (Polymer Physics-Phase Transition Dynamics, by Masao Doi, p. 2, published by Iwanami Shoten, Publishers, 1992). In the present invention, any liquid crystal compound may also be used, but a rod-shaped liquid crystal compound is preferably used.

Furthermore, in the present specification, it is not necessary for a compound having liquid crystallinity to be contained in the layer that is formed from a composition containing a liquid crystal compound. For example, the layer may contain a high molecular weight compound, no longer exhibiting liquid crystallinity, which is formed by carrying out polymerization or crosslinking of a low-molecular-weight liquid crystal compound having a reactive group with respect to heat, light, or the like, and thus capable of undergoing a reaction due to heat, light, or the like. Two or more rod-shaped liquid crystal compounds, two or more disc-shaped liquid crystal compounds, or a mixture of a rod-shaped liquid crystal compound and a disc-shaped liquid crystal compound may be used as the liquid crystal compound. The liquid crystal compound preferably has two or more polymerizable groups. In the case of a mixture of two or more kinds of liquid crystal compounds, it is preferable that at least one thereof have two or more polymerizable groups. In the case where the liquid crystal compound has two or more polymerizable groups, two or more polymerizable groups in the liquid crystal compound may be the same as each other or may be different from each other. Examples of the polymerizable group include a vinyl group, a (meth)acryl group, an epoxy group, an oxetanyl group, a vinyl ether group, a hydroxyl group, a carboxyl group, and an amino group.

For the two or more polymerizable groups, a liquid crystal compound containing two or more kinds of polymerizable group may be used. It is possible to manufacture a laminate showing patternwise optical anisotropy by crosslinking two or more kinds of polymerizable groups stepwise using such liquid crystal compounds. For example, it is possible to control the reaction according to the reaction conditions such as the kind of an initiator used, using a combination of a radically polymerizable group and cationically polymerizable group. A combination of a vinyl group, or a (meth)acryl group as the radically polymerizable group, as well as an epoxy group, an oxetanyl group, or a vinylether group as the cationically polymerizable group makes it easy to control the reactivity. Examples of the polymerizable group are shown below.

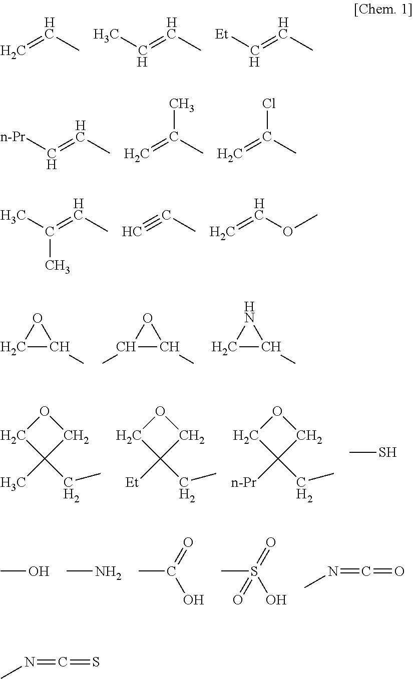

As the rod-shaped liquid crystal compound, azomethines, azoxy compounds, cyanobiphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenyl cyclohexylbenzonitriles are preferably used. Not only low-molecular-weight liquid crystal compounds as described above, but high-molecular-weight liquid crystal compounds can also be used. The high-molecular-weight liquid crystal compounds are high-molecular-weight compounds obtained by polymerizing low-molecular-weight rod-shaped liquid crystal compounds having a reactive group. Examples of the rod-shaped liquid crystal compounds include those described in JP2008-281989A, JP1999-513019A (JP-H11-513019A) (WO97/00600A), and JP2006-526165A.

Specific examples of rod-shaped liquid crystal compounds are given below. However, the present invention is not limited thereto. Further, the compound represented by general formula (I) can be synthesized by the method described in JP1999-513019A (JP-H11-513019A) (WO97/00600A).

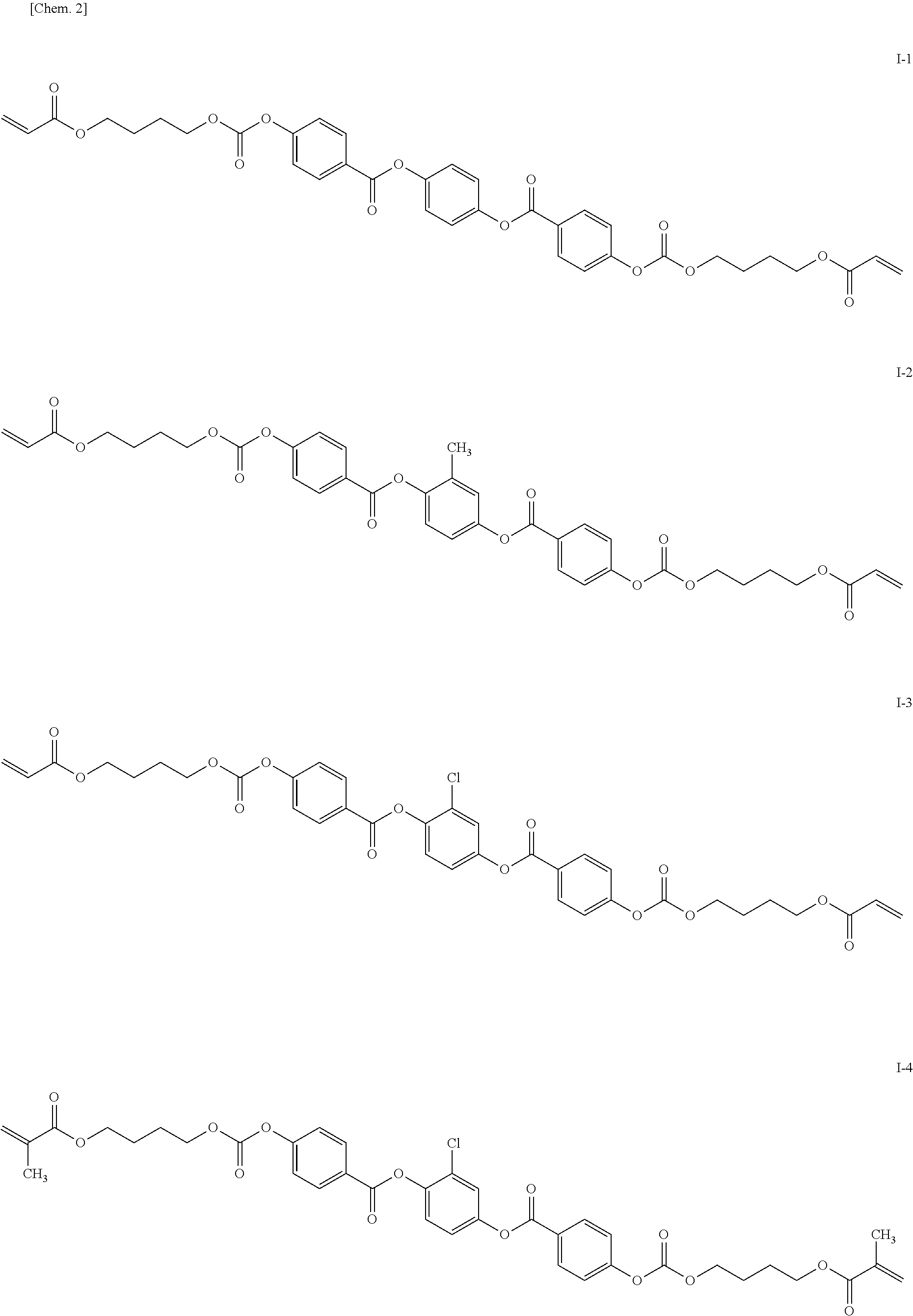

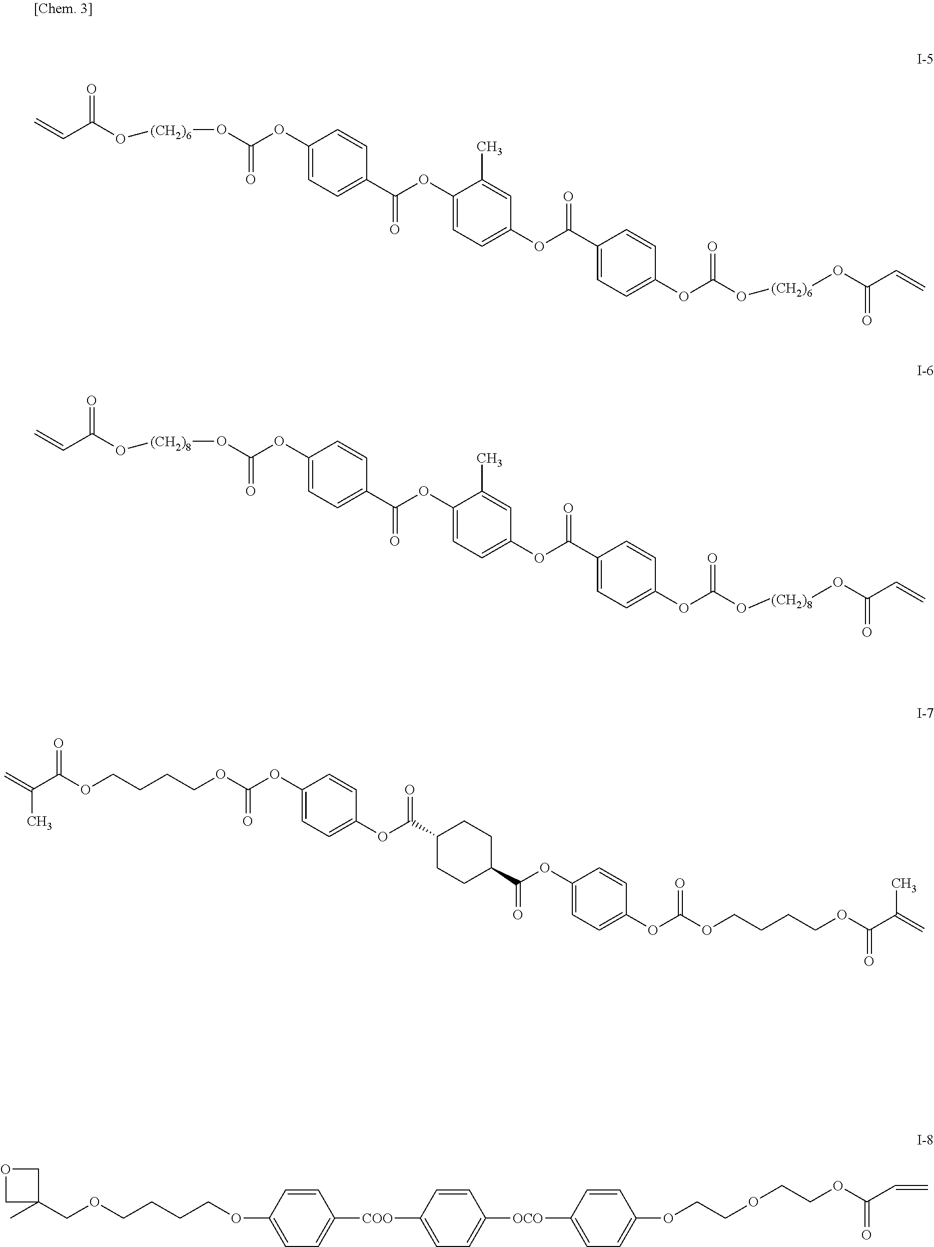

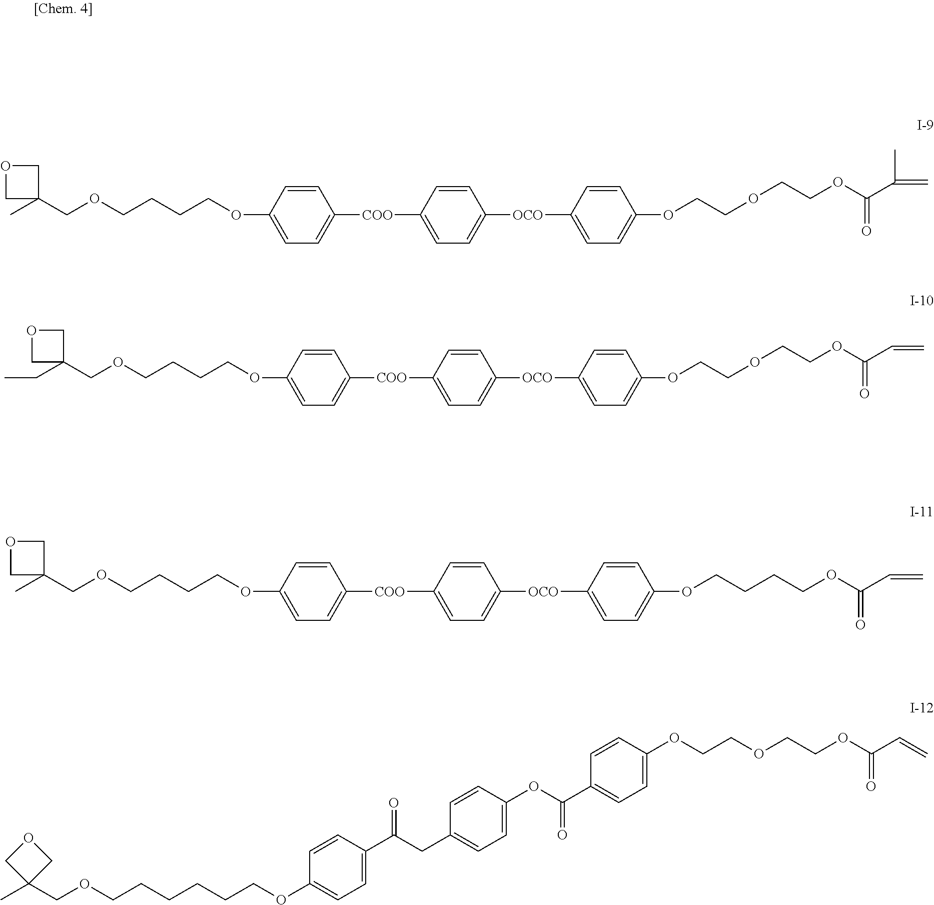

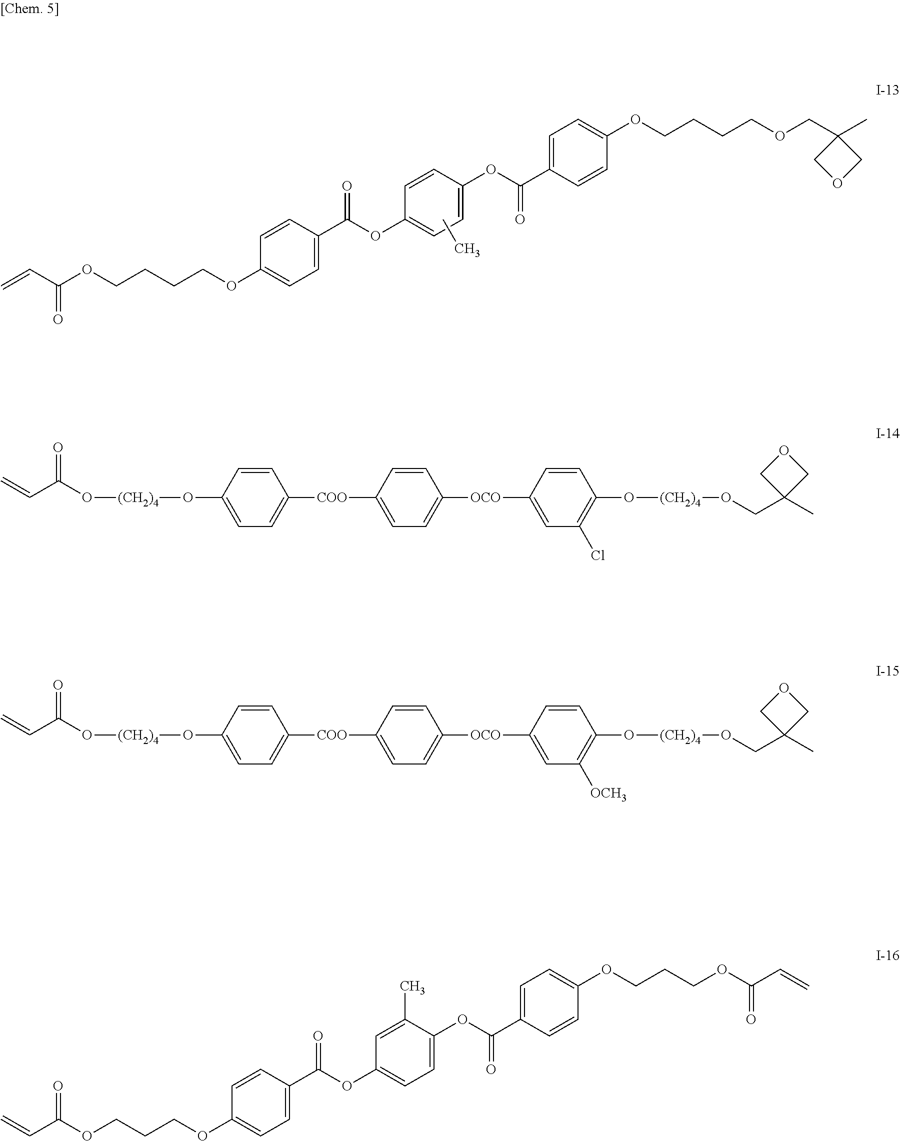

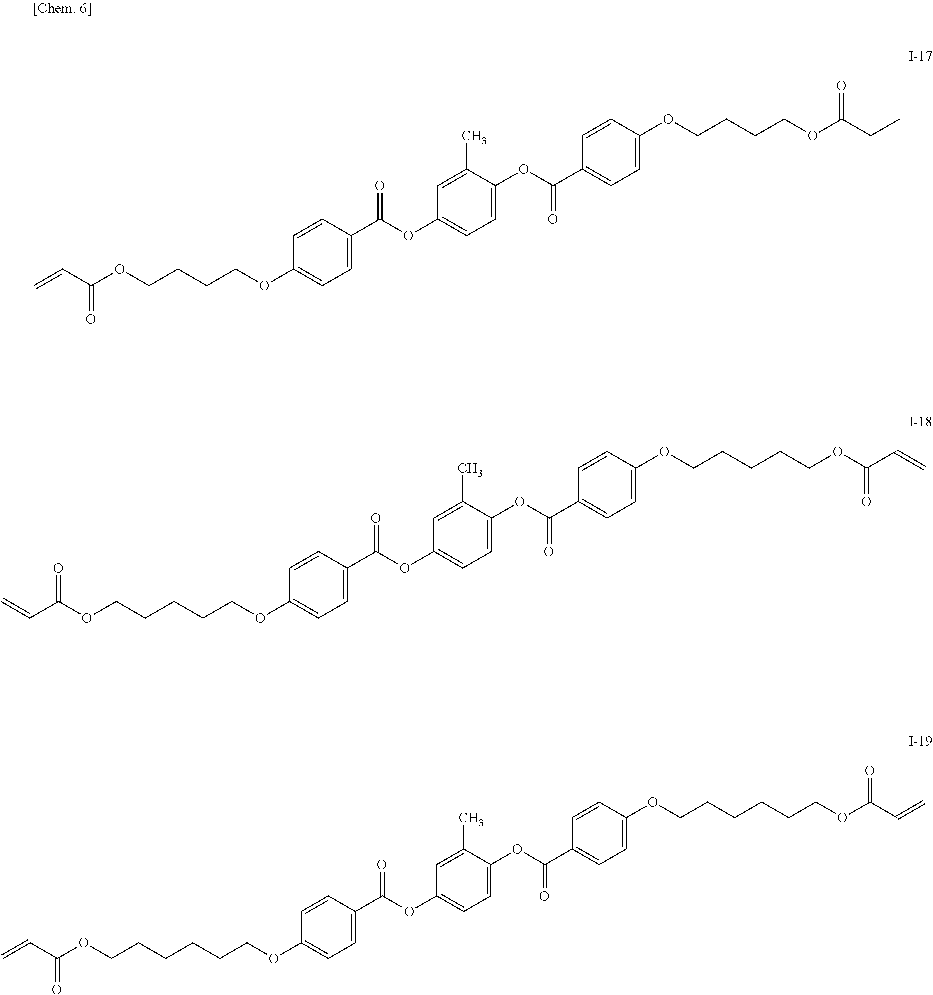

In another embodiment, there is an embodiment in which disc-shaped liquid crystal is used in the optically anisotropic layer. The optically anisotropic layer is preferably a layer of low molecular-weight disc-shaped liquid crystal compounds such as monomers, or a layer of polymers obtained by polymerizing (curing) polymerizable disc-shaped liquid crystal compounds. Examples of the disc-shaped liquid crystal compounds include the benzene derivatives described in the research report by C. Destrade et al., Mol. Cryst. Vol. 71, p. 111 (1981); the truxene derivatives described in the research report of C. Destrade et al., Mol. Cryst. Vol. 122, p. 141 (1985), and Physics Lett, A, Vol. 78, p. 82 (1990); the cyclohexane derivatives described in the research report of B. Kohne at el., Angew. Chem. Vol. 96, p. 70 (1984); and the aza-crown-based and phenyl acetylene-based macrocycles described in the research report of J. M. Lehn et al., J. Chem. Commun., p. 1,794 (1985) and the research report of J. Zhang et al., J. Am. Chem. Soc., Vol. 116, p. 2,655 (1994). These disc-shaped liquid crystal compounds generally have a structure with a disc-shaped base nucleus at the center of the molecule, having a group such as a linear alkyl group, an alkoxy group, and a substituted benzoyloxy group, substituted radially. They exhibit liquid crystallinity and include those generally referred to as disc-shaped liquid crystal. In the case where an aggregate of such molecules is oriented uniformly, it exhibits a negative uniaxial property. However, this description is not a limitation. Examples of disc-shaped liquid crystal compound include the compounds described in paragraphs [0061] to [0075] of JP2008-281989A.

The liquid crystal compound may be fixed in any of the orientation states of horizontal orientation, vertical orientation, inclined orientation, and twisted orientation. However, in the present specification, the term “horizontal orientation” refers, in the case of rod-shaped liquid crystal, to the major axis of the molecule being parallel to the horizontal surface of the laminate, and refers, in the case of disc-shaped liquid crystal, to the disc surface of the core of the disc-shaped liquid crystal compound being parallel to the horizontal surface of a transparent support. However, it is not required that they be strictly parallel; in the present specification, this refers to an orientation with an angle of incline relative to the horizontal surface of less than 10 degrees, preferably an orientation with an angle of incline of 0 degrees to 5 degrees, more preferably an orientation with an angle of incline of 0 degrees to 3 degrees, still more preferably an orientation with an angle of incline of 0 degrees to 2 degrees, and most preferably an orientation with an angle of incline of 0 degrees to 1 degree. The optically anisotropic layer of the present invention preferably includes those fixed in the state where the rod-shaped liquid crystal compound is horizontally oriented.

The liquid crystal compound may be included in an amount of preferably 30% by mass to 99.9% by mass, more preferably 50% by mass to 99.9% by mass, and even more preferably 70% by mass to 99.9% by mass, with respect to the total solid mass of the liquid crystal composition.

In the optically anisotropic layer formed by orienting and fixing a composition containing a liquid crystal compound, a polymerizable monomer may be added to promote crosslinking of the liquid crystal compound.

For example, a monomer or oligomer undergoing addition polymerization when irradiated with light and having two or more ethylenically unsaturated double bonds can be used.

Examples of such monomers and oligomers are compounds having at least one addition polymerizable, ethylenically unsaturated group per molecule. Examples thereof include monofunctional acrylates and monofunctional methacrylates such as polyethylene glycol mono(meth)acrylate, polypropylene glycol mono(meth)acrylate, and phenoxyethyl (meth)acrylate; polyethylene glycol di(meth)acrylate, polypropylene glycol di(meth)acrylate, trimethylolethane triacrylate, trimethylolpropane tri(meth)acrylate, trimethylolpropane diacrylate, neopentyl glycol di(meth)acrylate, pentaerythritol tetra(meth)acrylate, pentaerythritol tri(meth)acrylate, dipentaerythritol hexa(meth)acrylate, dipentaerythritol penta(meth)acrylate, hexanediol di(meth)acrylate, trimethylolpropane tri(acryloyloxypropyl)ether, tri(acryloyloxyethyl)isocyanurate, tri(acryloyloxyethyl)cyanurate, and glycerin tri(meth)acrylate; and polyfunctional acrylates and polyfunctional methacrylates such as compounds that have been (meth)acrylated after adding ethylene oxide or propylene oxide to a polyfunctional alcohol, such as trimethylolpropane and glycerin.

Additional examples thereof include the urethane acrylates described in JP1973-41708B (JP-S48-41708B), JP1975-6034B (JP-S50-6034B), and JP1976-37193A (JP-S51-37193A); the polyester acrylates described in W1973-64183A (JP-S48-64183 A), JP1974-43191B (JP-S49-43191B), and JP1977-30490B (JP-S52-30490B); and polyfunctional acrylates and methacrylates such as epoxyacrylates that are the reaction products of an epoxy resin with (meth)acrylic acid.

Among these, trimethylolpropane tri(meth)acrylates, pentaerythritol tetra(meth)acrylates, dipentaerythritol hexa(meth)acrylates, and dipentaerythritol penta(meth)acrylates are preferred.

Additional suitable examples thereof include the “polymerizable compound B” described in JP1999-133600A (JP-H11-133600A). These monomers or oligomers may be used singly or as a mixture of two or more kinds thereof.

Further, cationically polymerizable monomers may also be used. Examples thereof include the epoxy compounds, vinyl ether compounds, and oxetane compounds, which are given by way of example in each of JP1994-9714A (JP-H06-9714A), JP2001-31892A, JP2001-40068A, JP2001-55507A, JP2001-310938A, JP2001-310937A, and JP2001-220526A.

Examples of epoxy compounds include the aromatic epoxides, alicyclic epoxides, and aliphatic epoxides below. Examples of aromatic epoxides include bisphenol A, and di- or polyglycidyl ethers of alkylene oxide adducts thereof, hydrogenated bisphenol A and di- or polyglycidyl ethers of alkylene oxide adducts thereof, and novolac epoxy resins. Examples of alkylene oxides are ethylene oxide and propylene oxide.

Examples of the alicyclic epoxides include cyclohexene oxide and cyclopentene oxide-containing compounds obtained by epoxidizing a compound having at least one cycloalkane ring such as a cyclohexene or cyclopentene ring with a suitable oxidizing agent such as hydrogen peroxide or peroxy acid. Preferred examples of aliphatic epoxides include aliphatic polyalcohols and di- and polyglycidyl ethers of alkylene oxide adducts thereof. Representative examples thereof include diglycidyl ethers of alkylene glycols, such as diglycidyl ethers of ethylene glycol, diglycidyl ethers of propylene glycol, and diglycidyl ethers of 1,6-hexanediol; polyglycidyl ethers of polyalcohols such as di- or tri-glycidyl ethers of glycerin or alkylene oxide adducts thereof; diglycidyl ethers of polyethylene glycols or alkylene oxide adducts thereof; and diglycidyl ethers of polyalkylene glycols, such as diglycidyl ethers of polypropylene glycol and alkylene oxide adducts thereof. Here, examples of the alkylene oxide include ethylene oxide and propylene oxide.

Furthermore, a monofunctional or difunctional oxetane monomer may also be used as a cationically polymerizable monomer in the composition of the present invention. For example, compounds such as 3-ethyl-3-hydroxymethyloxetane (product name OXT101 or the like, manufactured by Toagosei Co., Ltd.), 1,4-bis[(3-ethyl-3-oxetanyl)methoxy-methyl]benzene (product name OXT121 or the like, manufactured by Toagosei Co., Ltd.), 3-ethyl-3-(phenoxymethyl)oxetane (product name OXT211 or the like, manufactured by Toagosei Co., Ltd.), di(1-ethyl-3-oxetanyl)methyl ether (product name OXT221 or the like, manufactured by Toagosei Co., Ltd.), 3-ethyl-3-(2-ethylhexyloxymethyl)oxetane (product name OXT212 or the like, manufactured by Toagosei Co., Ltd.), or the like can be preferably used. In particular, compounds such as 3-ethyl-3-hydroxymethyloxetane, 3-ethyl-3-(phenoxymethyl)oxetane, and di(1-ethyl-3-oxetanyl)methyl ether, and all known functional and difunctional oxetane compounds described in JP2001-220526A and JP2001-310937A can be used.

[Solvent]

An organic solvent is preferably used as a solvent for preparing a coating liquid in the case where a composition containing a liquid crystal compound is coated on the surface of a support or an orientation layer or the like as described later as the coating liquid. Examples of the organic solvent include amides (such as N,N-dimethylformamide), sulfoxides (such as dimethylsulfoxide), heterocyclic compounds (such as pyridine), hydrocarbons (such as benzene and hexane), alkyl halides (such as chloroform and dichloromethane), esters (such as methyl acetate and butyl acetate), ketones (such as acetone, methyl ethyl ketone, methyl isobutyl ketone, and cyclohexanone), and ethers (such as tetrahydrofuran and 1,2-dimethoxyethane). Further, a mixture of two or more kinds of solvent may be used. Among these, alkyl halides, esters, ketones, and a mixed solvent thereof are preferred.

[Fixing of Orientation]

The orientation of the liquid crystal compound is preferably fixed by a crosslinking reaction of polymerizable groups of the liquid crystal compound, and more preferably fixed by a polymerization reaction of polymerizable groups. Examples of polymerization reactions include a thermal polymerization reaction using a thermal polymerization initiator and a photopolymerization reaction using a photopolymerization initiator. A photopolymerization reaction is preferred. The photopolymerization reaction may be either radical polymerization or cation polymerization. Examples of the radical photopolymerization initiator include α-carbonyl compounds (described in U.S. Pat. No. 2,367,661A and U.S. Pat. No. 2,367,670A), acyloin ethers (described in U.S. Pat. No. 2,448,828A), α-hydrocarbon-substituted aromatic acyloin compounds (described in U.S. Pat. No. 2,722,512A), polynucleic quinone compounds (described in U.S. Pat. No. 3,046,127A and U.S. Pat. No. 2,951,758A), combinations of triarylimidazole dimers and p-aminophenyl ketones (described in U.S. Pat. No. 3,549,367A), acridine and phenazine compounds (described in JP1985-105667A (JP-S60-105667A) and U.S. Pat. No. 4,239,850A), and oxadiazole compounds (described in U.S. Pat. No. 4,212,970A). Examples of the cation photopolymerization initiator include organic sulfonium salts, iodonium salts, and phosphonium salts. The organic sulfonium salts are preferred, and triphenylsulfonium salts are particularly preferred. Hexafluoroantimonate, hexafluorophosphate, and the like are preferably used as the counter ions of these compounds.

The amount of the photopolymerization initiator to be used is preferably from 0.01% by mass to 20% by mass, and more preferably from 0.5% by mass to 5% by mass of the solid contents of the coating liquid. Ultraviolet rays are preferably used for the light irradiation to polymerize the liquid crystal compound. The irradiation energy is preferably from 10 mJ/cm² to 10 J/cm², and more preferably from 25 mJ/cm² to 1000 mJ/cm². The illuminance is preferably from 10 mW/cm² to 2000 mW/cm², more preferably from 20 mW/cm² to 1500 mW/cm², and even more preferably from 40 mW/cm² to 1000 mW/cm². The illumination wavelength preferably has a peak at 250 nm to 450 nm, and more preferably has a peak at 300 nm to 410 nm. To promote the photopolymerization reaction, the light irradiation may be carried out under an inert gas atmosphere such as nitrogen or under heated conditions.

[Non-Ionic Surfactant not Containing Fluoride and Silicon and Having Average Molecular Weight of 6000 or Less]

The liquid crystal composition for the manufacture of the optically anisotropic layer in the laminate of the present invention preferably contains a non-ionic surfactant not containing fluoride and silicon. Further, this non-ionic surfactant preferably has an average molecular weight of 6000 or less (surfactants not containing fluoride and silicon, having an average molecular weight of 6000 or less will be hereinafter referred to as a “non-F.Si-based surfactant” in some cases). By the studies conducted by the present inventors, it has been found that the use of such a surfactant provides an orientation controlling property for liquid crystal molecules and allows coatability of a liquid crystal composition, and at the same time, good coatability onto an optically anisotropic layer thus manufactured, and therefore, problems such as whitening hardly occur. By using such a non-ionic surfactant, the molecules of the liquid crystal compound can be essentially horizontally oriented.

The non-F.Si-based surfactant is not particularly limited as long as it satisfies the conditions that it does not contain fluoride and silicon, and has an average molecular weight of 6000 or less. The average molecular weight (mass average molecular weight) is preferably 5000 or less, more preferably 4000 or less, and even more preferably 1500 or less. Specific examples thereof include polyoxyethylene alkyl ether, sorbitan ester, alkyl polyglucoside, fatty acid diethanolamide, alkyl monoglyceryl ether, acetylene alcohol, and acetylene glycol. Among these, acetylene alcohol and acetylene glycol are preferred.

Examples of the acetylene glycol-based compound include 104 series such as Surfynol 104PA, Surfynol 104E, Surfynol 104H, and Surfynol 104A; 400 series such as Surfynol 420, Surfynol 440, Surfynol 465, and Surfynol 485; and Surfynol SE, Surfynol SE-F, Dynol 604, Dynol 607, Olfine, Exp4400, Exp4123, E1004, Olfine 1010, Olfine PD-001, and Olfine PD-005, all manufactured by Nissin Chemical Industry Co., Ltd.

The amount of the non-F.Si-based surfactant is preferably from 0.01% by mass to 0.5% by mass, and particularly preferably from 0.02% by mass to 0.3% by mass, with respect to the total mass of the liquid crystal compound.

The liquid crystal composition for the manufacture of the optically anisotropic layer in the laminate of the present invention may or may not include a surfactant other than the non-F.Si-based surfactant, but it is preferable that the liquid crystal composition do not contain the surfactant. In particular, preferably, the liquid crystal composition does not include a non-ionic surfactant containing fluoride or silicon (which will be hereinafter described as a “F.Si-based surfactant” in some cases).

Specific examples of the F.Si-based surfactant include “MEGAFAC F-110”, “MEGAFAC F-113”, “MEGAFAC F-120”, “MEGAFAC F-812”, “MEGAFAC F-142D”, “MEGAFAC F-144D”, “MEGAFAC F-150”, “MEGAFAC F-171”, “MEGAFAC F-173”, “MEGAFAC F-177”, “MEGAFAC F-183”, “MEGAFAC F-195”, “MEGAFAC F-824”, “MEGAFAC F-833”, “MEGAFAC F-114”, “MEGAFAC F-410”, “MEGAFAC F-493”, “MEGAFAC F-494”, “MEGAFAC F-443”, “MEGAFAC F-444”, “MEGAFAC F-445”, “MEGAFAC F-446”, “MEGAFAC F-470”, “MEGAFAC F-471”, “MEGAFAC F-474”, “MEGAFAC F-475”, “MEGAFAC F-477”, “MEGAFAC F-478”, “MEGAFAC F-479”, “MEGAFAC F-480SF” “MEGAFAC F-482” “MEGAFAC F-483” “MEGAFAC F-484”, “MEGAFAC F-486” “MEGAFAC F-487” “MEGAFAC F-489” “MEGAFAC F-172D”, “MEGAFAC F-178 K”, “MEGAFAC F-178 RM”, and “MEGAFAC F-472SF” (all manufactured by DIC Corporation); and “TEGO Rad2100”, “TEGO Rad2200N”, “TEGO Rad2250”, “TEGORad2300”, “TEGO Rad2500”, “TEGO Rad2600”, and “TEGO Rad2700” (all manufactured by Evonik Tego Chemie GmbH).

[Isotropic Resin Layer Laminated on Optically Anisotropic Layer]

Examples of the isotropic resin layer laminated on the optically anisotropic layer include an orientation layer for providing an additional optically anisotropic layer, a protective layer of an optically anisotropic layer, a scattering layer that controls the scattering of transmitted light, a hard coat layer that prevents the scratching of a lower layer, an antistatic layer that prevents adhesion of debris due to charge buildup, and a printing coating layer that becomes an undercoat for printing. The isotropic resin layer may be a layer including a polymerization initiator for the reaction of unreacted polymerizable groups in the optically anisotropic layer.

The isotropic resin layer may be a polymer layer. The layer is not particularly limited, but examples thereof include a polymethyl (meth)acrylate, a copolymer of (meth)acrylic acid and various esters thereof, a polystyrene, a copolymer of styrene and (meth)acrylic acid or various (meth)acrylic acid esters, a polyvinyltoluene, a copolymer of vinyltoluene and (meth)acrylic acid or various (meth)acrylic acid esters, a styrene/vinyltoluene copolymer, polyvinyl chloride, polyvinylidene chloride, polyvinyl acetate, a vinyl acetate/ethylene copolymer, a vinyl acetate/vinyl chloride copolymer, a polyester, a polyimide, carboxymethylcellulose, polyethylene, polypropylene, and polycarbonate. Preferred examples thereof include a copolymer of methyl (meth)acrylate and (meth)acrylic acid, a copolymer of allyl (meth)acrylate and (meth)acrylic acid, and a multi-component copolymer of benzyl (meth)acrylate and (meth)acrylic acid with other monomers. These polymers may be used singly or in combination of plural kinds thereof. The content of the polymer with respect to the entire solid contents is generally from 20% by mass to 99% by mass, preferably from 40% by mass to 99% by mass, and more preferably from 60% by mass to 98% by mass.

In addition, the thickness of the isotropic resin layer is not particularly limited, but it is preferably from 0.2 μm to 10 μm, and more preferably from 0.4 μm to 5 μm.

[Surfactant in Isotropic Resin Layer]

The isotropic resin layer, that is, the composition for forming an isotropic resin layer may include a surfactant from the viewpoint of effectively preventing unevenness or the like. As the surfactant, a non-ionic surfactant not containing fluoride and silicon is preferred, and the molecular weight (average molecular weight) thereof is not particularly limited. The weight average molecular weight, Mw, is preferably from 50 to 40000, and more preferably from 100 to 20000. Specific examples of the surfactant included in the isotropic resin layer include sorbitan esters, alkyl polyglucoside, fatty acid diethanolamide, acetylene alcohol, and acetylene glycol. Among these, acetylene alcohol and acetylene glycol are preferred.

Examples of the acetylene glycol-based compound include 104 series such as Surfynol 104PA, Surfynol 104E, Surfynol 104H, and Surfynol 104A; 400 series such as Surfynol 420, Surfynol 440, Surfynol 465, and Surfynol 485; and Surfynol SE, Surfynol SE-F, Dynol 604, Dynol 607, Olfine, Exp4400, Exp4123, E1004, Olfine 1010, Olfine PD-001, and Olfine PD-005, all manufactured by Nissin Chemical Industry Co., Ltd.

The amount of the surfactant is preferably 0.01% by mass to 5.0% by mass, and more preferably from 0.01% by mass to 3.0% by mass, with respect to the solid contents of the isotropic resin layer.

It is preferable that the composition for forming an isotropic resin layer do not include a non-ionic surfactant containing fluoride and silicon. Similarly, it is also preferable that the composition for forming an isotropic resin layer do not include a non-ionic surfactant containing fluoride or a non-ionic surfactant containing silicon.

Further, the composition for forming an isotropic resin layer may contain a solvent. In addition, by including a solvent, the formation according to various coating methods as described later become easier. The solvent used is not particularly limited, but examples thereof include amides (such as N,N-dimethylformamide), sulfoxides (such as dimethylsulfoxide), heterocyclic compounds (such as pyridine), hydrocarbons (such as benzene and hexane), alkyl halides (such as chloroform and dichloromethane), esters (such as methyl acetate and butyl acetate), ketones (such as acetone, methyl ethyl ketone, methyl isobutyl ketone, and cyclohexanone), and ethers (such as tetrahydrofuran and 1,2-dimethoxyethane). Further, two or more kinds of solvent may be mixed and used. Among the solvents, alkyl halides, esters, ketones, and mixed solvents thereof are particularly preferred. The proportion of the solvent (in the case of a mixed solvent, the sum thereof) during the coating is preferably from 60% by mass to 99% by mass, more preferably from 70% by mass to 98% by mass, and particularly preferably from 80% by mass to 95% by mass, with respect to the total mass of the composition for forming an isotropic resin layer.

[Support]

The laminate of the present invention may have a support to maintain dynamic stability. The support is not particularly limited, and may be either a rigid support or a flexible support, but the flexible support is preferred. The rigid support is not particularly limited, but examples thereof include known glass plates such as a soda glass plate having a silicon oxide coating on the surface, low-expansion glass, non-alkali glass, and a quartz glass plate; metal plates such as an aluminum plate, an iron plate, and an SUS plate; resin plates; ceramic plates; and stone plates. The flexible support is not particularly limited, but examples thereof include plastic films such as cellulose esters (such as cellulose acetate, cellulose propionate, and cellulose butyrate), polyolefins (such as a norbornene-based polymer), poly(meth)acrylic acid esters (such as polymethyl methacrylate), polycarbonates, polyesters, polysulfones, and norbornene-based polymers; paper, aluminum foil, and cloth. From the viewpoint of ease of handling, the thickness of the rigid support is preferably from 100 μm to 3000 μm, and more preferably from 300 μm to 1500 μm. The thickness of the flexible support is preferably from 3 μm to 500 μm, and more preferably from 10 μm to 200 μm.

[Orientation Layer]

The laminate of the present invention may have an orientation layer. The orientation layer functions to determine the orientation direction of the liquid crystal compound in the layer provided thereon. The orientation layer can be any layer as long as it imparts an orientation property to the optically anisotropic layer. Preferred examples of the orientation layer include rubbed layers of organic compounds (preferably polymers); optical orientation layers that exhibit a liquid crystal orienting property by irradiation with polarized light, such as azobenzene polymers and polyvinyl cinnamate; oblique vapor deposition layers of inorganic compounds; microgrooved layers; cumulative films of ω-tricosanoic acid, dioctadecyl methyl ammonium chloride, methyl stearate, or the like formed by the Langmuir-Blodgett method (LB method); and layers in which a dielectric is oriented by imparting an electric or magnetic field. In the rubbed form of orientation layers, polyvinyl alcohol is preferably included, and the ability to crosslink with at least one layer either above or below the orientation layer is particularly preferred. An optical orientation layer and microgrooves are preferred as methods of controlling the orientation direction. Compounds which exhibit an orientation property based on dimers, such as polyvinyl cinnamate, are particularly preferred for the optical orientation layer. An embossing treatment with a master roll manufactured in advance by mechanical or laser processing is particularly preferred for microgrooves.

[Layer on Isotropic Resin Layer]

Another layer may be provided on the laminate of the present invention so as to prepare various laminates. By a configuration where the surface energy of the surface on the side of the isotropic resin layer of the laminate is 34.0 mN/m or more, when a layer is formed through a step in which a composition is directly coated onto the isotropic resin layer in the outermost layer of the laminate of the present invention, a cissing problem does not easily occur and the coatability is good. The layer directly formed on the isotropic resin layer is preferably a resin layer including a polymer.

Examples of the new layer provided on the isotropic resin layer include an additional optically anisotropic layer, an orientation layer for providing the additional optically anisotropic layer, a protective layer, a scattering layer that controls the scattering of transmitted light, a hard coat layer that prevents the scratching of a lower layer, an antistatic layer that prevents adhesion of debris due to charge buildup, and a printing coating layer that becomes an undercoat for printing.

The additional optically anisotropic layer may be formed in the same manner as for the optically anisotropic layer as described above, and may be formed as a layer obtained by directly coating the liquid crystal composition onto the isotropic resin layer.

[Coating Method]

Each of layers such as the optically anisotropic layer, the isotropic resin layer, the orientation layer, and the layer on the isotropic resin layer can be formed by coating a coating solution by a dip coating method, an air knife coating method, a spin coating method, a slit coating method, a curtain coating method, a roller coating method, a wire bar coating method, a gravure coating method, or an extrusion coating method (U.S. Pat. No. 2,681,294A). Two or more layers may be simultaneously coated. Simultaneous application methods are described in U.S. Pat. No. 2,761,791A, U.S. Pat. No. 2,941,898A, U.S. Pat. No. 3,508,947A, and U.S. Pat. No. 3,526,528A, and in Yuji Harazaki, Coating Technology, p. 253, Asakura Publishing Co., Ltd. (1973).

### EXAMPLES

The present invention will be described in more detail with reference to Examples below. The materials, reagents, material quantities, and their proportions, operations, and the like indicated in Examples below can be suitably modified without departing from the scope or spirit of the present invention. Accordingly, the scope of the present invention is not limited to the specific examples given below.

### Preparation of Optically Anisotropic Layer Coating Liquid LC-1

The following composition was prepared, filtered through a filter made of polypropylene with a pore diameter of 30 μm, and used as an optically anisotropic layer coating liquid LC-1.

Composition (%) of the optically anisotropic layer coating liquid

| | |
|---|---|
| Polymerizable liquid crystal compound (RM257, | 14.91 |
| manufactured by Merck Co., Ltd.) | |
| Polymerization initiator (Irgacure 907, manufactured by | 0.46 |
| Ciba Specialty Chemicals K.K. Japan) | |
| Non-F•Si-based surfactant (Olfine Exp4200, manufactured | 0.05 |
| by Nissin Chemical Industry Co., Ltd.) | |
| Methyl ethyl ketone | 64.58 |
| Cyclohexanone | 20.00 |

### Preparation of Optically Anisotropic Layer Coating Liquid LC-2

The following composition was prepared, filtered through a polypropylene filter with a pore diameter of 30 μm, and used as an optically anisotropic layer coating liquid LC-2.

Composition (%) of the optically anisotropic layer coating liquid

| | |
|---|---|
| Polymerizable liquid crystal compound (RM257, | 14.91 |
| manufactured by Merck Co., Ltd.) | |
| Polymerization initiator (Irgacure 907, manufactured by | 0.46 |
| Ciba Specialty Chemicals K.K. Japan) | |
| Non-F•Si-based surfactant (Olfine Exp4123, manufactured | 0.05 |
| by Nissin Chemical Industry Co., Ltd.) | |
| Methyl ethyl ketone | 64.58 |
| Cyclohexanone | 20.00 |

### Preparation of Optically Anisotropic Layer Coating Liquid LC-3

The following composition was prepared, filtered through a polypropylene filter with a pore diameter of 30 μm, and used as an optically anisotropic layer coating liquid LC-3.

Composition (%) of the optically anisotropic layer coating liquid

| | |
|---|---|
| Polymerizable liquid crystal compound (RM257, | 14.91 |
| manufactured by Merck Co., Ltd.) | |
| Polymerization initiator (Irgacure 907, manufactured by | 0.46 |
| Ciba Specialty Chemicals K.K. Japan) | |
| Non-F•Si-based surfactant (Surfynol 104PA, manufactured | 0.05 |
| by Nissin Chemical Industry Co., Ltd.) | |
| Methyl ethyl ketone | 64.58 |
| Cyclohexanone | 20.00 |

### Preparation of Isotropic Resin Layer Coating Liquid A-1

The following composition was prepared, filtered through a polypropylene filter with a pore diameter of 0.4.5 μm, and used as an isotropic resin layer coating liquid A-1

Composition (% by mass) of Isotropic Resin Layer Coating Liquid

| | |
|---|---|
| Polymer (Dianal BR-87, manufactured by Mitsubishi | 8.10 |
| Rayon Co., Ltd.) | |
| Non-F•Si-based surfactant (Olfine Exp4200, | 0.02 |
| manufactured by Nissin Chemical Industry Co., | |
| Ltd.) | |
| Methyl ethyl ketone | 81.88 |
| Cyclohexanone | 10.00 |

### Preparation of Isotropic Resin Layer Coating Liquid A-2

The following composition was prepared, filtered through a polypropylene filter with a pore diameter of 0.45 μm, and used as an isotropic resin layer coating liquid A-2.

Composition (% by mass) of Isotropic Resin Layer Coating Liquid

| | |
|---|---|
| Polymer (Dianal BR-87, manufactured by Mitsubishi | 8.10 |
| Rayon Co., Ltd.) | |
| Non-F•Si-based surfactant (Olfine Exp4123, | 0.02 |
| manufactured by Nissin Chemical Industry Co., | |
| Ltd.) | |
| Methyl ethyl ketone | 81.88 |
| Cyclohexanone | 10.00 |

### Preparation of Isotropic Resin Layer Coating Liquid A-3

The following composition was prepared, filtered through a polypropylene filter with a pore diameter of 0.45 μm, and used as an isotropic resin layer coating liquid A-3.

Composition (% by mass) of Isotropic Resin Layer Coating Liquid

| | |
|---|---|
| Polymer (Dianal BR-87, manufactured by Mitsubishi | 8.10 |
| Rayon Co., Ltd.) | |
| Non-F•Si-based surfactant (Surfynol 104PA, | 0.02 |
| manufactured by Nissin Chemical Industry Co., | |
| Ltd.) | |
| Methyl ethyl ketone | 81.88 |
| Cyclohexanone | 10.00 |

### Preparation of Laminated Resin Layer Coating Liquid B-1

A Flexo ink (UV Flexo 500, manufactured by T&K TOKA Corporation) was used as a laminated resin layer coating liquid B-1.

### Example 1

### Manufacture of Laminate in which Isotropic Resin Layer is Laminated on Optically Anisotropic Layer Formed by Coating of Liquid Crystal Composition Including Non-F.Si-Based Surfactant

(Manufacture of Laminate T-01)

An optically anisotropic layer coating liquid LC-1 was coated on the surface of a TAC film having a thickness of 50 μm, which had been subjected to a rubbing treatment, using a wire bar, and was dried at a temperature of the film surface of 90° C. for 2 minutes to give a state of a liquid crystal phase. Then, the coating was irradiated with ultraviolet rays using an air-cooled metal halide lamp (manufactured by Eye Graphics Co., Ltd.) at 160 W/cm in air, and the orientation state was fixed to form an optically anisotropic layer having a thickness of 2.6 μm. The illumination of ultraviolet rays used at this time was 600 mW/cm² in a UV-A region (integration of wavelengths 320 nm to 400 nm), and the irradiance was 300 mJ/cm² in the UV-A region. The retardation of the optically anisotropic layer was 280 nm and the layer was a polymer which was solid at 20° C. Further, the tilt angle as measured was 0.6°. Finally, the isotropic resin layer coating liquid A-1 was coated on the optically anisotropic layer using a wire bar, and dried to form an isotropic resin layer having a film thickness of 1.0 μm, thus manufacturing a laminate T-01 having an optically anisotropic layer, in which whitening could not been seen. A laminated resin layer coating liquid B-1 was coated on the laminate T-01 using a test coater for a print test. The coating was irradiated with ultraviolet rays using an air-cooled metal halide lamp (manufactured by Eye Graphics Co., Ltd.) at 160 W/cm in air and cured to form a laminated resin layer having a thickness of 0.5 μm, thereby manufacturing a laminate T-11 having an optically anisotropic layer. The illumination of ultraviolet rays used at this time was 500 mW/cm² in a UV-A region (integration of wavelengths 320 nm to 400 nm), and the irradiance was 400 mJ/cm² in the UV-A region.

### Example 2

### Manufacture of Laminate in which Isotropic Resin Layer is Laminated on Optically Anisotropic Layer Formed by Coating of Liquid Crystal Composition Including Non-F.Si-Based Surfactant

In the same manner as in Example 1, except that LC-2 and A-2 were used as the optically anisotropic layer coating liquid and the isotropic resin layer coating liquid, respectively, laminates T-02 and T-12 were manufactured. The tilt angle after coating the LC-02 was 0.4°. Further, the whitening could not be seen as in the laminate T-01.

### Example 3

### Manufacture of Laminate in which Isotropic Resin Layer is Laminated on Optically Anisotropic Layer Formed by Coating of Liquid Crystal Composition Including Non-F.Si-Based Surfactant

In the same manner as in Example 1, except that LC-3 and A-3 were used as the optically anisotropic layer coating liquid and the isotropic resin layer coating liquid, respectively, laminates T-03 and T-13 were manufactured. The tilt angle after coating the LC-02 was 0.8°. Further, the whitening could not be seen as in the laminate T-01.

(Method for Measuring Surface Energy)

The surface energy γs of the laminate was determined by measuring a contact angle of pure water and methylene iodide to the laminate. From the measured contact angle, the surface energy was calculated using the following extended Fowkes equation (Equation 1).

γ_{L}(1+cos θ)=2(γ_{Sd}·γ_{Ld})^{1/2}+2(γ_{Sp}·γ_{Lp})^{1/2} Equation 1

γ_{L}=γ_{Ld}+γ_{Lp} Equation 2

γ_{S}=γ_{Sd}+γ_{Sp} Equation 3

θ represents a contact angle (°), γ_{L} represents the surface energy of the liquid used for the measurement of the contact angle, γ_{Ld} represents a dispersed component of the surface energy of the liquid used for the measurement of the contact angle, and γ_{Lp} is a polar component of the surface energy of the liquid used for the measurement of the contact angle, and is an existing value. For pure water, γ_{Ld}=21.8 mN/m and γ_{Lp}=51.0 mN/m, and for methylene iodide, γ_{Ld}=49.5 mN/m and γ_{Lp}=1.3 mN/m were used to calculate γ_{S}. In addition, γ_{Sd} is a dispersed component of the surface energy of the laminate, and γ_{Sp} is a polar component of the surface energy of the laminate.

(Measurement of Surface Energy of Laminate)

The values of surface energy of the laminates T-01, T-02, and T-03 were measured, and were 45.4 mN/m, 43.9 mN/m, and 41.9 mN/m, respectively.

### Comparative Example 1

### Manufacture of Laminate in which Isotropic Resin Layer is Laminated on Optically Anisotropic Layer Formed by Coating of Liquid Crystal Composition Including F-Containing Non-ionic Surfactant

### Preparation of Optically Anisotropic Layer Coating Liquid LC-4

The following composition was prepared, filtered through a polypropylene filter with a pore diameter of 30 μm, and used as an orientation layer coating liquid LC-4.

Composition (%) of Optically Anisotropic Layer Coating Liquid

| | |
|---|---|
| Polymerizable liquid crystal compound (RM257, | 14.91 |
| manufactured by Merck Co., Ltd.) | |
| Polymerization initiator (Irgacure 907, manufactured by | 0.46 |
| Ciba Specialty Chemicals K.K. Japan) | |
| F-Containing Non-Ionic Surfactant (MEGAFAC F556, | 0.05 |
| manufactured by DIC Corporation) | |
| Methyl ethyl ketone | 64.58 |
| Cyclohexanone | 20.00 |

In the same manner as in Example 1, except that LC-4 was used as the optically anisotropic layer coating liquid, laminates P-01 and P-11 were manufactured. The tilt angle after coating the LC-04 was 0.5°.

### Comparative Example 2

### Manufacture of Laminate in which Isotropic Resin Layer is Laminated on Optically Anisotropic Layer Formed by Coating of Liquid Crystal Composition Including Si-Containing Surfactant

### Preparation of Optically Anisotropic Layer Coating Liquid LC-5

The following composition was prepared, filtered through a polypropylene filter with a pore diameter of 30 μm, and used as an optionally anisotropic layer coating liquid LC-5.

Composition (%) of Optically Anisotropic Layer Coating Liquid

| | |
|---|---|
| Polymerizable liquid crystal compound (RM257, | 14.91 |
| manufactured by Merck Co., Ltd.) | |
| Polymerization initiator (Irgacure 907, manufactured by | 0.46 |
| Ciba Specialty Chemicals K.K. Japan) | |
| Si-Containing non-ionic surfactant (TEGO Flow 425, | 0.05 |
| manufactured by Evonik TEGO Chemie) | |
| Methyl ethyl ketone | 64.63 |
| Cyclohexanone | 20.00 |

In the same manner as in Comparative Example 1, except that LC-5 was used as the optically anisotropic layer coating liquid, laminates P-02 and P-12 were manufactured. The tilt angle after coating the LC-05 was 1.0°.

(Measurement of Surface Energy of Laminate)

The values of surface energy of the laminates P-01 and P-02 were measured and were 30.4 mN/m and 33.0 mN/m, respectively.

(Evaluation of Coatability During Lamination)

The cissing evaluation of the respective layer coating liquids during the manufacture of the laminates T11 to T13 and P11 to 13 are shown in Table 1.

TABLE 1

| | Cissing of | Cissing of | Cissing of |
|---|---|---|---|
| | optically | isotropic | laminated |
| | anisotropic | resin layer | resin layer |
| | layer coating | coating | coating |
| | liquid | liquid | liquid |
| T-11 (the present | Absent | Absent | Absent |
| invention) | | | |
| T-12 (the present | Absent | Absent | Absent |
| invention) | | | |
| T-13 (the present | Absent | Absent | Absent |
| invention) | | | |
| P-11 (Comparative | Absent | Present | Present |
| Example) | | | |
| P-12 (Comparative | Absent | Present | Present |
| Example) | | | |

A result of evaluation was that, for the laminates having a surface energy of 34.0 mN/m or more, the laminated resin layer coating liquid could be coated without cissing, while the lamination onto the optically anisotropic layer containing F.Si and having a surface energy of less than 34.0 mN/m had undergone generation of cissing, and lamination could be not done.

### Reference Example 1

### Manufacture of Laminate in which Isotropic Resin Layer is Laminated on Optically Anisotropic Layer Formed by Coating of Liquid Crystal Composition Including no Surfactant

### Preparation of Optically Anisotropic Layer Coating Liquid LC-6

The following composition was prepared, filtered through a polypropylene filter with a pore diameter of 30 μm, and used as an optionally anisotropic layer coating liquid LC-5.

Composition (%) of Optically Anisotropic Layer Coating Liquid

| | |
|---|---|
| Polymerizable liquid crystal compound (RM257, | 14.91 |
| manufactured by Merck Co., Ltd.) | |
| Polymerization initiator (Irgacure 907, manufactured by | 0.46 |
| Ciba Specialty Chemicals K.K. Japan) | |
| Methyl ethyl ketone | 64.63 |
| Cyclohexanone | 20.00 |

In the same manner as in Comparative Example 1, except that LC-6 was used as the optically anisotropic layer coating liquid, a laminate P-03 was manufactured. When the LC-6 was coated, cissing occurred.

What is claimed is:

1. A laminate comprising:
an optically anisotropic layer; and
an isotropic resin layer formed of a resin composition directly coated on the optically anisotropic layer,
wherein the optically anisotropic layer is a layer formed by curing a liquid crystal composition including a liquid crystal compound containing a polymerizable group,
the isotropic resin layer is the outermost layer of the laminate, and
the surface energy on the side of the isotropic resin layer of the laminate is 34.0 mN/m or more.

2. The laminate according to claim 1, wherein the liquid crystal compound has two or more polymerizable groups.

3. The laminate according to claim 1, wherein the liquid crystal composition includes a non-ionic surfactant not containing fluoride and silicon.

4. The laminate according to claim 2, wherein the liquid crystal composition includes a non-ionic surfactant not containing fluoride and silicon.

5. The laminate according to claim 3, wherein the average molecular weight of the surfactant is 6000 or less.

6. The laminate according to claim 4, wherein the average molecular weight of the surfactant is 6000 or less.

7. The laminate according to claim 3, wherein the surfactant is an acetylene diol-based surfactant or acetylene glycol-based surfactant.

8. The laminate according to claim 1, wherein the liquid crystal composition does not include a non-ionic surfactant containing fluoride or silicon.

9. The laminate according to claim 1, wherein the molecules of the liquid crystal compound are horizontally oriented.

10. The laminate according to claim 1, wherein the resin composition does not include a non-ionic surfactant containing fluoride or silicon.

11. The laminate according to claim 1, wherein the resin composition does not include a non-ionic surfactant containing fluoride and a non-ionic surfactant containing silicon.

12. The laminate according to claim 1, wherein the resin composition includes a non-ionic surfactant not containing fluoride and silicon.

13. The laminate according to claim 12, wherein the content of the non-ionic surfactant not containing fluoride and silicon in the resin composition is from 0.01% by mass to 1.0% by mass with respect to the solid mass of the isotropic resin layer.

14. The laminate according to claim 1, wherein the resin composition includes a solvent.

15. The laminate according to claim 14, wherein in the resin composition, the solvent included in the resin composition is contained in the amount of 60% by mass to 99% by mass with respect to the total mass of the resin composition.

16. The laminate according to claim 1, wherein in the liquid crystal composition, the content of the non-ionic surfactant not containing fluoride and silicon is from 0.01% by mass to 0.5% by mass with respect to the total mass of the liquid crystal compound.

17. The laminate according to claim 1, wherein the thickness of the optically anisotropic layer is from 0.5 μm to 10 μm.

18. The laminate according to claim 1, wherein the thickness of the isotropic resin layer is from 0.4 μm to 5 μm.

19. A laminate comprising an additional layer formed of a composition directly coated on the isotropic resin layer of the laminate according to claim 1.

20. A method for manufacturing the laminate according to claim 1 including an optically anisotropic layer, an isotropic resin layer, and an additional resin layer in this order, adjacent to each other, comprising:
a step of curing a liquid crystal composition including a liquid crystal compound containing a polymerizable group to form an optically anisotropic layer;
a step of coating a resin composition directly onto the optically anisotropic layer to form an isotropic resin layer having a surface energy of 34.0 mN/m or more; and
a step of coating the composition directly onto the isotropic resin layer to form an additional layer.
